(19) United States
(12) Patent Application Publication
(10) Pub. No.: US 2015/0223095 A1
(43) Pub. Date: Aug. 6, 2015

(54) Method for Configuring a Dual Connectivity User Equipment

(71) Applicant: Telefonaktiebolaget L M Ericsson (publ), Stockholm (SE)

(72) Inventors: Angelo CENTONZA, Winchester (GB); Icaro L.J. DA SILVA, Sollentuna (SE); Fredrik GUNNARSSON, Linkoping (SE)

(73) Assignee: Telefonaktiebolaget L M Ericsson (publ), Stockholm (SE)

(21) Appl. No.: 14/539,128

(22) Filed: Nov. 12, 2014

Related U.S. Application Data
(60) Provisional application No. 61/934,125, filed on Jan. 31, 2014.

(51) Int. Cl. H04W 24/10

(52) U.S. Cl. CPC H04W 24/10; H04W 88/06

(57) ABSTRACT

This disclosure describes, among other things, a method for configuring a dual connectivity user equipment (UE). In some embodiments, the method comprises: a first network node receiving link performance information with respect to the performance of a user plane between a second network node and the UE; the first network node determining a measurement report triggering parameter based on the received link performance information; and the first network node transmitting to the UE a message comprising the measurement report triggering parameter. In some embodiments, the link performance information may comprise one or more of: (i) Reference Signal Received Power (RSRP) information, (ii) Reference Signal Received Quality (RSRQ) information, (iii) channel quality indicator (CQI) information, and (iv) power headroom information.

### CROSS-REFERENCE TO RELATED APPLICATIONS

The present application claims the benefit of priority to U.S. Provisional Application Ser. No. 61/934,125, filed on Jan. 31, 2014, which is incorporated herein by reference in its entirety.

### TECHNICAL FIELD

Disclosed herein are, for example, methods, network nodes, and computer program products for configuring a dual connectivity user equipment (UE).

### BACKGROUND

Network densification—increasing the number of network nodes, and thereby bringing them physically closer to the user terminals—is one way to improve traffic capacity and extend the achievable user-data rates of a wireless communication system. In addition to densification of a macro network nodes (e.g., macro base stations (a.k.a., macro cells), such as macro Evolved Node Bs (“eNBs” or “eNodeBs”)), network densification can be achieved by the deployment of complementary low-power network nodes (e.g., low-power base stations (a.k.a., small cells), such as small eNBs) under the coverage of an existing macro network node. In such a heterogeneous deployment, the low-power network nodes provide very high traffic capacity and very high user throughput locally (e.g., in indoor and outdoor hotspot positions). Meanwhile, the macro node ensures service availability and quality of experience (QoE) over the entire coverage area. In other words, the low power nodes provide local-area access, in contrast to the macro node, provides wide-area coverage.

The installation of low-power network nodes as well as heterogeneous deployments has been possible since the first release of Long Term Evolution (LTE). Additional features—extending the capabilities to operate in heterogeneous deployments—were added to the LTE specifications as part of Releases 10 and 11. More specifically, these releases introduced additional tools to handle inter-node interference in heterogeneous deployments. During further evolution of LTE (e.g., Release 12 and beyond) this trend will continue. This means further enhancements related to low-power network nodes and heterogeneous deployments will be considered under the umbrella of “small-cell enhancements” activities.

Some of these activities will focus on achieving an even higher degree of interworking between the macro and low-power network nodes, including different forms of macro assistance to the low-power node and dual connectivity. As outlined in FIG. 1, dual connectivity implies that a device 102 has simultaneous connections to both a macro node 104 and a low-power node 106. Dual connectivity may imply control and data separation where, for instance, the control signaling for mobility is provided via the macro node 104 at the same time as high-speed data connectivity is provided via the low-power node 106. Dual connectivity may imply a separation between downlink and uplink, where downlink and uplink connectivity is provided via different node. Dual connectivity may imply diversity for control signaling, where Radio Resource Control (RRC) signaling may be provided via multiple links, further enhancing mobility performance.

In TR 36.842 (Study on Small Cell Enhancements for E-UTRAN and UTRAN; Higher Layer Aspects), some scenarios and challenges were presented concerning dual connectivity architectures. In one scenario (“Scenario 1”), macro and small cells in the same frequency are connected via non-ideal backhaul. In this scenario, achieving mobility robustness may be challening. More Handover Failure (while moving a UE from one serving cell to another), Radio Link Failure (while being in connected mode with a serving cell) would be expected upon mobility from small to macro. In TR 36.839, some analysis are performed. In a second scenario (“Scenario 2”), macro and small cells are in different frequencies.

The term “dual connectivity” may refer to operation where a given user equipment (UE) consumes radio resources provided by at least two different network nodes, which may be connected with non-ideal backhaul. Furthermore, each Evolved Node B (eNB) involved in dual connectivity for a UE may assume different roles. Those roles do not necessarily depend on the eNB's power class and can vary among UEs.

Inter-node radio resource aggregation may improve per-user throughput for Scenario 2. This can be done by aggregating radio resources in more than one eNB for user plane data transmission, as illustrated in FIG. 2. Depending on the particular realization of this solution, signaling overhead towards the core network (CN) can potentially be saved by keeping the mobility anchor in the macro cell, as described below with reference to the radio link failure (RLF) detection model.

Inter-node radio resource aggregation may improve cell edge throughput in Scenario 1, which allows one UE to be scheduled via multiple eNBs. FIG. 3 shows an example in a first user equipment UE1 in small cell edge could be served by a macro cell 304 in non-Almost Blank Subframe (ABS) to utilize macro cell radio resources and by a small cell 306 in ABS to utilize small cell radio resources. Hence, the per-user throughput can be increased by utilizing radio resources in more than one eNB (e.g., by utilizing radio resources in eNBs 304 and 306).

Radio Resource Control (RRC) diversity may improve mobility robustness. With RRC diversity, as illustrated in FIG. 4, the handover related RRC signaling could additionally be transmitted from or to a potential target cell. In this case, Radio Link Failure (RLF) could be prevented as long as the UE 402 is able to maintain a connection to at least one of the macro cell 404 and small cell 406, which is shown as a pico base station in FIG. 4. This may lead to a more successful handover performance (i.e., avoiding UE RRC re-establishment procedure). The RRC diversity scheme could also be applied for handovers from the macro to small cells, between macro cells, or between small cells.

RRC diversity is activated and deactivated based on an A3 RSRP measurement event between macro and small with a hysteresis value of 2 dB (considering Cell Selection Offset (CSO) for small inbound HOs), whereas the handover is initiated based on an A3 Reference Signal Received Power (RSRP) measurement event of 4 dB (always considering CSO). A3 in this case denotes a mobility event defined in TS36.331v12.2.0 as follows: “Event A3 (Neighbour becomes offset better than PCell)”. This way, RRC diversity is always activated prior to the initiation of the handover procedure, i.e. including the cell range expansion area.

Accordingly, RRC diversity provides significant gains in terms of mobility robustness for a scenario with cell range expansion gains in terms of offloading potential while keeping the mobility robustness issues within reasonable bounds.

As explained below, an uplink (UL)/downlink (DL) imbalance can occur for UEs in heterogeneous networks because of large difference in the transmit power of the macro and small cells. The consequence is an uneven load distribution between macro and small cells (e.g., small cells less loaded than macro cells) and suboptimal uplink performance because a UE is not necessarily connected to the eNB with smallest path loss. In addition, to transmit power imbalance, there may be UL/DL traffic load imbalance. A small eNB may be highly loaded in DL while unloaded in UL. It may then be beneficial to offload a macro UE's UL data to the small eNB while keeping the UE's DL traffic in the macro.

As discussed below, Cell Range Extension (CRE) based cell selection can be used to improve the UL/DL imbalance situation. However, CRE for the intra-frequency deployments results in strong DL interference for small UEs in the CRE region. CRE must therefore be used in combination with time domain Inter-Cell Interference Coordination (ICIC), which has a negative impact on the overall system capacity due to the reduction of schedulable subframes.

To increase offloading of the macro by the small cells and to improve UL performance, an alternative solution is to have dual connectivity to both eNBs and allow the UE to be connected in DL to the cell which offers the highest DL throughput while being connected in the UL to the cell which offers the highest UL throughput, which is typically the cell to which the path loss is lowest. This is particularly beneficial for the case where the macro and small nodes operate on the same frequency, as the possible Cell Selection Offset (CSO) is limited due to DL interference problems in the CRE region.

UL/DL split provides also the advantage to apply load balancing separately for UL and DL, achieving optimal cell capacity in UL and DL. The network has the possibility to shift more UL traffic to the small cell if the macro eNB is loaded in the UL while keeping DL traffic in the macro eNB. This is beneficial for both intra-frequency and inter-frequency deployments.

In UL/DL split, even though the UL traffic and DL traffic is routed via different eNBs, it is assumed that local scheduling and local Hybrid Automatic Repeat reQuest (HARQ)-feedback is needed as relaxed requirements on the backhaul are assumed.

Two architecture alternatives to achieve UL/DL split are foreseen, one with bearer split and one with separate bearers. In the bearer split alternative, one bearer is split over the small eNB and the macro eNB (e.g., the UL part of the bearer is routed via the small eNB while the DL part of the bearer is routed via the macro eNB). In this alternative, it may not be required to have Physical Downlink Shared CHannel (PDSCH) from the small eNB and Physical Uplink Shared CHannel (PUSCH) to the macro eNB. Radio Link Control (RLC) Status Reports could be sent locally or routed via the backhaul. In the separate bearer alternative, there are two bearers: one bearer to the macro eNB and another bearer to the small eNB. In this alternative, there will be PUSCH and PDSCH to both the macro eNB and the small eNB, and RLC Status reports are sent locally.

FIG. 5 illustrates an example of this architecture alternative where UL/DL split is used to route UL traffic via the small eNB 506 and DL traffic via the macro eNB 504. The UE 502 would send UL traffic on the PUSCH to the small eNB 506 and receive DL traffic on the PDSCH from the macro eNB 504 while RLC Status reports are sent locally (i.e. RLC Status reports for DL traffic from the macro eNB are sent on the PUSCH to the macro eNB while RLC Status reports for UL traffic to the small eNB are received on the PDSCH from the small eNB).

An architecture supporting aggregation of the user plane (UP) from different eNBs may be very similar to an architecture supporting UL/DL split.

Carrier Aggregation (CA)+enhanced Interference Cancellation and Interference Coordination (eICIC) may improve per-user throughput for Scenario 2. This can be done by deploying more than one frequency layer at both macro cell and small cell and applying eICIC for both Primary Cell (PCell) and Secondary Cell (SCell). However, low-cost small cell may only have one frequency layer.

A user plane architecture may be used for dual connectivity. Here, dual connectivity consists in configuring a UE with one macro eNB, which may be a Master eNB (MeNB) and at least one small eNB, which may be a Slave eNB (SeNB). There are 3 options for splitting the U-Plane data. In Option 1, S1-User Plane (S1-U, namely part of the S1 interface dedicated at transferring user plane traffic) terminates in the SeNB. In Option 2, S1-U terminates in MeNB, and there is no bearer split in the radio access network (RAN). In Option 3, S1-U terminates in MeNB, and there is bearer split in the RAN. FIG. 6 illustrates these three options taking the downlink direction as an example.

In terms of protocol architecture, when S1-U terminates at the MeNB, the protocol stack in the SeNB must at least support (re-)segmentation. This is due to (re-)segmentation being an operation that is tightly coupled to the physical interface, and, when non-ideal backhaul is used, (re-)segmentation must take place in the same node as the one transmitting the Radio Link Control (RLC) Packet Data Units (PDUs). Based on this assumption, four families of U-plane alternatives emerge: Independent Packet Data Convergence Protocols (PDCPs), Master-Slave PDCPs, Independent RLCs, and Master-Slave RLCs.

With Independent PDCPs, the currently defined air-interface U-plane protocol stack terminates completely per bearer at a given eNB and is tailored to realize transmission of one EPS bearer by one node. However, the air-interface U-plane protocol stack could also support splitting of a single EPS bearer for transmission by MeNB and SeNB with the help of an additional layer. The transmission of different bearers may still happen simultaneously from the MeNB and a SeNB.

With Master-Slave PDCPs, S1-U is assumed to terminate in MeNB with at least part of the PDCP layer residing in the MeNB. In case of bearer split, there is a separate and independent RLC bearer (also at UE side) per eNB configured to deliver PDCP PDUs of the PDCP bearer, terminated at the MeNB.

With Independent RLCs, S1-U is assumed to terminate in MeNB with the PDCP layer residing in the MeNB. In case of bearer split, there is a separate and independent RLC bearer (also at UE side) per eNB configured to deliver PDCP PDUs of the PDCP bearer, terminated at the MeNB.

With Master-Slave RLCs, S1-U is assumed to terminate in MeNB with the PDCP layer and part of the RLC layer residing in the MeNB. While requiring only one RLC entity in the UE for the EPS bearer, on the network side, the RLC functionality is distributed between the nodes involved with a “slave RLC” operating in the SeNB. In downlink, the slave RLC takes care of the delay-critical RLC operation needed at the SeNB. For instance, the slave RLC receives from the master RLC at the MeNB readily built RLC PDUs (with Sequence Number already assigned by the master) that the master has assigned for transmission by the slave, and transmits them to the UE. The custom-fitting of these PDUs into the grants from the Medium Access Control (MAC) scheduler is achieved by re-using the currently defined re-segmentation mechanism.

Based on the options for bearer split and U-plane protocol stack above, the following alternatives exist: (1A) S1-U terminates in SeNB and independent PDCPs (no bearer split); (2A) S1-U terminates in MeNB, no bearer split in MeNB, and independent PDCP at SeNB; (2B) S1-U terminates in MeNB, no bearer split in MeNB, and master-slave PDCPs; (2C) S1-U terminates in MeNB, no bearer split in MeNB, and independent RLC at SeNB; (2D) S1-U terminates in MeNB, no bearer split in MeNB, and master-slave RLCs; (3A) S1-U terminates in MeNB, bearer split in MeNB, and independent PDCPs for split bearers; (3B) S1-U terminates in MeNB, bearer split in MeNB, and master-slave PDCPs for split bearers; (3C) S1-U terminates in MeNB, bearer split in MeNB, and independent RLCs for split bearers; and (3D) S1-U terminates in MeNB, bearer split in MeNB, and master-slave RLCs for split bearers.

In the following, the benefits and drawbacks of each alternative are analyzed. It is noted that those alternatives only represent how dual connectivity can be realized for one UE. The alternatives do not restrict the handling of bearers of other UEs (e.g., it is not because alternative 2C is used for one UE that legacy UEs cannot connect directly to SeNB).

With regard to user plane architecture, alternatives 1A and 3C may support the U-plane data split options of Option 1 and 3 described above with reference to FIG. 6.

Alternative 1A is the combination of an S1-U terminating in SeNB and independent PDCPs (no bearer split). FIG. 7 illustrates Alternative 1A, taking the downlink direction as an example. The benefits of Alternative 1A may include: (i) no need for the MeNB 704 to buffer or process packets for an Evolved Packet System (EPS) bearer transmitted by the SeNB 706; (ii) little or no impact to PDCP/RLC and GTP-U/UDP/IP; (iii) no need to route all traffic to MeNB 704, low requirements on the backhaul link between MeNB 704 and SeNB 706, and no flow control needed between the two; and (iv) support of local break-out and content caching at SeNB 706 being straightforward for dual connectivity UEs. The drawbacks of Alternative 1A may include: (i) SeNB mobility being visible to CN; (ii) offloading needing to be performed by a Mobility Management Entity (MME) and not being very dynamic; (iii) security being impacted due to ciphering being required in both MeNB 704 and SeNB 706; (iv) no possibility for utilization of radio resources across MeNB 704 and SeNB 706 for the same bearer; (v) for the bearers handled by SeNB 706, handover-like interruption at SeNB changing with forwarding between SeNBs; and (vi) in the uplink, logical channel prioritisation impacting the transmission of uplink data (e.g., radio resource allocation being restricted to the eNB where the Radio Bearer terminates).

Alternative 3C is the combination of S1-U terminating in MeNB, bearer split in MeNB, and independent RLCs for split bearers. FIG. 8 illustrates Alternative 3C, taking the downlink direction as an example. The expected benefits of Alternative 3C may include: (i) SeNB mobility being hidden to CN; (ii) no security impacts with ciphering being required in MeNB 804 only; (iii) no requirement of data forwarding between SeNBs at SeNB change; (iv) offloading RLC processing of SeNB traffic from MeNB 804 to SeNB 806; (v) little or no impact to RLC; (vi) the possibility of utilizating radio resources across MeNB 804 and SeNB 806 for the same bearer possible; and (vii) relaxed requirements for SeNB mobility (e.g., MeNB can be used in the meantime). The expected drawbacks of Alternative 3C may include: (i) the need to route, process, and buffer all dual connectivity traffic in MeNB; (ii) PDCP becoming responsible for routing PDCP PDUs towards eNBs for transmission and reordering them for reception; (iii) flow control being required between MeNB 804 and SeNB 806; (iv) in the uplink, logical channel prioritization impacts for handling RLC retransmissions and RLC Status PDUs (restricted to the eNB where the corresponding RLC entity resides); and (v) no support of local break-out and content caching at SeNB for dual connectivity UEs.

Control plane (C-plane or CP) protocols and architectures may be used to realize dual connectivity. From a standards point of view, each eNB should be able to handle UEs autonomously (i.e., should be able to provide the PCell to some UEs while acting as assisting eNB for other UEs). In the discussion below, it is assumed that there will be only one S1-MME Connection per UE. In dual connectivity operation, the SeNB owns its radio resources and is primarily responsible for allocating radio resources of its cells. Some coordination is still needed between MeNB and SeNB to enable this as discussed below.

In regard to a Radio Resource Control (RRC) Protocol architecture, at least the following RRC functions may be relevant when considering adding a small cell layer to the UE for dual connectivity operation: (i) the small cell layer's common radio resource configurations, (ii) the small cell layer's dedicated radio resource configurations, and (iii) measurement and mobility control for small cell layer.

In dual connectivity operation, a UE always stays in a single RRC state (i.e., either RRC_CONNECTED or RRC_IDLE). With this principle, there are two main architecture alternatives for RRC, and these options are illustrated in FIG. 9. In the first RRC protocol architecture option (“Option C1”), only the MeNB 904a generates the final RRC messages to be sent towards the UE 902a after the coordination of Radio Resource Management (RRM) functions between the MeNB 904a and SeNB 906a. The RRC entity of UE 902a sees all messages coming only from one entity (in the MeNB), and the UE 902a only replies back to that entity. L2 transport of these messages depends on the chosen UP architecture and the intended solution.

In the second RRC protocol architecture option (“Option C2”), MeNB 904b and SeNB 906b can generate final RRC messages to be sent towards the UE 902b after the coordination of RRM functions between MeNB 904b and SeNB 906b and may send those directly to the UE (depending on L2 architecture), and the UE 902b replies accordingly. L2 transport of these messages depends on the chosen UP architecture and the intended solution.

The potential benefits and drawbacks between different examples of RRC protocol architectures are discussed below. The examples are not limiting, and there might be other ways to perform configurations as well. The examples consider the initial SeNB radio resource configuration or the situation when the radio resource configuration of the SeNB needs to be changed. For C-plane Option C1, at least the following steps could be needed: (1) the MeNB provides input parameters (e.g., UE capabilities and the radio resource configuration of the UE) to the SeNB; (2) the SeNB decides the relevant parameters relevant (e.g., Physical Uplink Control Channel (PUCCH) configuration) and signals these to the MeNB; and (3) based on input from the SeNB, the MeNB generates the final RRC message and signals this message to the UE. L2 transport of these messages depends on the chosen UP architecture and the intended solution.

In the above procedures, Step 1 can be skipped in cases when it can be guaranteed that RRCConnectionReconfiguration is valid and in line with the UE capabilities. Such cases could be, for example, when the SeNB already has the latest information of the UEs radio resource configuration in the MeNB or the parameters are not subject to the capabilities.

To interconnect eNBs via X2 for dual connectivity specific Transport Network Layer (TNL) signaling, at least the following additional X2 control plane functions are necessary for dual connectivity: (i) establishment, maintenance and release of a UE context at the SeNB (including handling a corresponding UE context related signaling connection); (ii) control of user plane paths between MeNB and SeNB for a specific UE (for U-plane option 3C for a specific UE and for data forwarding); (iii) transfer of the TNL information of the S1 user plane paths for 1A; and (iv) transfer of radio configuration related information between MeNB and SeNB for a specific UE. (e.g., performed in an X2 transparent way).

In regard to the details of control plane features, the following general principles are applied for the operation of dual connectivity. (1) The MeNB maintains the RRM measurement configuration of the UE and may (e.g, based on received measurement reports or traffic conditions or bearer types) decide to ask an SeNB to provide additional resources (serving cells) for a UE. (2) Upon receiving the request from the MeNB, an SeNB may create the container that will result in the configuration of additional serving cells for the UE (or decide that it has no resource available to do so). (3) The MeNB and the SeNB exchange information about UE configuration by means of RRC containers (inter-node messages) carried in Xn messages. (4) The SeNB may initiate a reconfiguration of its existing serving cells (e.g., PUCCH towards the SeNB). (5) The MeNB does not change the content of the RRC configuration provided by the SeNB.

In regard to Xn interface assumptions, independent of the radio interface protocol solutions, an interface between MeNB and SeNB involved in dual connectivity is defined as Xn, and the same transport layer protocol as S1/X2 could be used for Xn (i.e., SCTP over IP for C-plane and GTP-U over UDP/IP for U-plane). If the Xn interface is not the bottleneck, packet loss on Xn may be rare in reasonable load conditions. This cannot be guaranteed in high load or overload situations. Packet loss may occur in case of transport network congestion. Sufficient dimensioning of the backhaul is crucial. There is a case that packets are delivered on Xn in the wrong order, but this is also rare in reasonable load conditions. If packet loss and re-ordering occurs on Xn, U-plane protocols shall not stall, but do not need to be corrected either. GTP-U may ensure in-sequence delivery so that U-plane protocols do not need to care about out-of-order packets. Xn may be, for example, X2 with some additions.

The overall Evolved Universal Terrestrial Radio Access Network (E-UTRAN) architecture as specified in TS 36.300 is applicable for dual connectivity as well. Inter-eNB signaling for dual connectivity operation may be performed by means of X2 interface signaling.

General frameworks for dual connectivity may include one or more of the following features: (i) the maximum total number of serving cells per UE is 5 as for carrier aggregation, (ii) carrier aggregation is supported in the MeNB and the SeNB (i.e., the MeNB and the SeNB may have multiple serving cells for a UE); (iii) in dual connectivity, a UE is connected to one MeNB and one SeNB; (iv) a target area group (TAG) may only comprise cells of one eNB; and (v) Main Cell Group (MCG) and Secondary Cell Group (SCG) may operate either in the same or different duplex schemes (whether cells within the MCG or the SCG can operate with different duplex schemes is pending RANI decision on TDD/FDD carrier aggregation).

In regard to PCell functionality in SCG, the SeNB may have to have one special cell containing at least PUCCH and potentially also some other PCell functionality. However, it is not necessary to duplicate all PCell functionality for the special cell. The special cell in SCG may include one or more of the following features: (i) no need to provide Non-Access Stratum (NAS) security and NAS mobility functions in the SeNB; (ii) at least one cell in SeNB has configured UL, and one of them is configured with PUCCH resources; (iii) no Radio Link Management (RLM) is needed on a cell not carrying PUCCH in the SeNB; (iv) RLF, if supported, of any SCG cell does not trigger RRC connection re-establishment; (v) the cell in the SeNB that is configured with PUCCH resources cannot be cross-carrier scheduled; and (vi) semi-persistent scheduling may not be needed in the SeNB.

In regard to bearer split modelling, the selected user plane architecture of Alternatives 1A and 3C may include on or more of the following features: (i) Alternatives 1A and/or 3C may be realized by RRC configuration, and deviations in the protocol stack for different configurations may be limited (e.g., a new specification of PDCP-SeNB may not be introduced); (ii) some bearers of a UE may be split (see Alternative 3C) while others are only served by the MeNB; (iii) some bearers of a UE may be served by the SeNB (see Alternative 1A) while others are only served by the MeNB; (iv) a bearer/UE currently split across SeNB and MeNB (see Alternative 3C) may not be able to be reconfigured to be served only via the SeNB (see Alternative 1A) and vice versa unless the SeNB is released and re-added; (v) some bearers of a UE may be split (see Alternative 3C) while others are served by the SeNB (see Alternative 1A); (vi) RLC STATUS PDUs are transmitted to corresponding eNBs via the corresponding Uu interface; (vii) UL data may be transmitted to one eNB only or may be split across eNBs.

In regard to Radio Link Failure (RLF) Detection in a known architecture that does not have dual connectivity, as is illustrated in FIG. 10, Qout may be monitored with a 200 ms window, and Qin may be monitored with a 100 ms window (as specified in TS 36.133 Requirements for Radio Resource Management). Both windows are updated once per frame (i.e., once every 10 ms) with the measured wideband channel quality indicator (CQI) value. If a UE detects that its average wideband CQI value is lower than Qout, it will report an out-of-sync event. Thereafter, if the UE detects that its average wideband CQO value is higher than Qin, the UE will report an in-sync event. When the out-of-sync event has been reported N310 times, the eNB will start T310 timer, which is the time limit to decide whether an RLF occurs. If the in-sync event is detected less than N311 times when the T310 timer expires, an RLF occurs. Otherwise, the T310 timer is aborted.

With dual connectivity, the UE can be configured to also monitor SeNB links, and report to MeNB when there are issues with the SeNB link. Issues with the SeNB link could be due to SeNB physical layer reception, MAC issues, and/or RLC issues similar to what can be observed for radio link monitoring in legacy LTE for the MeNB.

The existing mechanisms for radio link monitoring and radio link failure handling are focused on the scenario when the UE is served by one cell that is also terminating the radio resource control protocol to the UE. The existing mechanisms do not address the situation when the UE can be configured to operate in dual connectivity with links to multiple cells where a cell may not terminate radio resource control but only user plane and enough control plane mechanisms to support the user plane link. Furthermore, the existing mechanisms do not manage secondary links via report triggering mechanisms.

### SUMMARY

One aspect provides a method for configuring a dual connectivity user equipment (UE). The method may comprise a first network node receiving link performance information with respect to the performance of a user plane between a second network node and the UE. The first network node may determine a measurement report triggering parameter based on the received link performance information. The first network node may transmit to the UE a message comprising the measurement report triggering parameter.

In some embodiments, the link performance information may comprise one or more of: (i) Reference Signal Received Power (RSRP) information, (ii) Reference Signal Received Quality (RSRQ) information, (iii) channel quality indicator (CQI) information, and (iv) power headroom information. In some embodiments, the link performance information may comprise one or more of the CQI information and the power headroom information. In some embodiments, the link performance information may comprise (a) one or more of the RSRP information and RSRQ information and (b) one or more of the CQI information and the power headroom information. In some embodiments, the first network node may use the link performance information to decide whether to perform bearer release/transfer.

In some embodiments, the first network node may be a macro node, and the second network node may be a low power network node. In some embodiments, the step of determining the report triggering parameter may comprise calculating a rate of failure with respect to connection attempts. In some embodiments, calculating the rate of failure with respect to connection attempts may comprise: determining X, where X is the number of connections during a time window; determining Y, where Y is the number of link performance failures that i) corresponds to one or more of an RSRP value, an RSRQ value, a CQI value, and a power headroom value and ii) occurred during the time window; determining Y/X; determining whether Y/X<t, wherein t is a predetermined threshold; and, in response to determining that Y/X is less than t, setting the report triggering parameter equal to the one or more of the RSRP value, the RSRQ value, the CQI value, and the power headroom value.

Another aspect of the invention provides a network node for configuring a dual connectivity user equipment (UE). The network node may comprise a computer system and a computer readable medium. The computer readable medium may store computer readable instructions executable by said computer system whereby said network node is operative to: receive link performance information with respect to the performance of a user plane between a second network node and the UE; determine a measurement report triggering parameter based on the received link performance information; and transmit to the UE a message comprising the measurement report triggering parameter.

Another aspect of the invention provides a computer program product for configuring a dual-connectivity user equipment (UE). The computer program product may comprise a non-transitory computer readable medium storing computer readable instructions. The instructions may comprise: instructions for receiving link performance information with respect to the performance of a user plane between a second network node and the UE; instructions for determining a measurement report triggering parameter based on the received link performance information; and instructions for transmitting to the UE a message comprising the measurement report triggering parameter.

Another aspect of the invention provides a method comprising a dual connectivity user equipment (UE) transmitting link performance information to a first network node. The link performance information may relates to the performance of a user plane between a second network node and the UE. The method may comprise the UE receiving a message comprising a measurement report triggering parameter based on the transmitted link performance information from the first network node; and the UE using the measurement report triggering parameter to determine whether to transmit a report to the first network node.

In some embodiments, the link performance information may comprise one or more of: (i) Reference Signal Received Power (RSRP) information, (ii) Reference Signal Received Quality (RSRQ) information, (iii) channel quality indicator (CQI) information, and (iv) power headroom information. In some embodiments, the report trigging parameter may be a threshold value, and using the measurement report triggering parameter to determine whether to transmit the report to the first network node may comprise the UE comparing a radio condition to the threshold value to determine whether the report should be sent to the first network node. In some embodiments, the radio condition may be Reference Signal Received Power (RSRP), Reference Signal Received Quality (RSRQ), or channel quality indicator (CQI).

Another aspect of the invention provides a dual connectivity user equipment (UE) comprising a computer system and a computer readable medium. The computer readable medium may store computer readable instructions executable by said computer system whereby said UE is operative to: transmit link performance information to a first network node, wherein the link performance information relates to the performance of a user plane between a second network node and the UE; receive a message comprising a measurement report triggering parameter based on the transmitted link performance information from the first network node; and use the measurement report triggering parameter to determine whether to transmit a report to the first network node.

In some embodiments, the link performance information may comprise one or more of: (i) Reference Signal Received Power (RSRP) information, (ii) Reference Signal Received Quality (RSRQ) information, (iii) channel quality indicator (CQI) information, and (iv) power headroom information. In some embodiments, the report trigging parameter may be a threshold value, and using the measurement report triggering parameter to determine whether to transmit the report to the first network node may comprise comparing a radio condition to the threshold value to determine whether the report should be sent to the first network node.

Another aspect of the invention provides a method for configuring a dual connectivity user equipment (UE). The method may comprise: a first network node providing to the UE a first report triggering threshold; the first network node receiving link performance information with respect to the performance of a user plane between a second network node and the UE; the first network node determining, based on the received link performance information, whether the performance of the user plane meets an acceptable performance threshold; and, in response to a determination that the performance of the user plane does not meet the acceptable performance threshold, the first network node providing to the UE a second report triggering threshold.

In some embodiments, the second report triggering threshold may be higher than the first report triggering threshold. In some embodiments, the method may comprise, in response to a determination that the performance of the user plane meets the acceptable performance threshold, the first network node providing to the UE a third report triggering threshold. In some embodiments, the third report triggering threshold may be lower than the first report triggering threshold. In some embodiments, the third report triggering threshold may be the same as the first report triggering threshold.

In some embodiments, the link performance information may comprise one or more of: (i) Reference Signal Received Power (RSRP) information, (ii) Reference Signal Received Quality (RSRQ) information, (iii) channel quality indicator (CQI) information, and (iv) power headroom information. In some embodiments, the link performance information may comprise one or more of the CQI information and the power headroom information. In some embodiments, the link performance information may comprise (a) one or more of the RSRP information and RSRQ information and (b) one or more of the CQI information and the power headroom information. In some embodiments, the first network node may use the link performance information to decide whether to perform bearer release/transfer. In some embodiments, the first network node may be a macro node, and the second network node may be a low power network node.

Another aspect of the invention provides a network node for configuring a dual connectivity user equipment (UE). The network node may comprise a computer system and a computer readable medium. The computer readable medium may store computer readable instructions executable by said computer system whereby said network node is operative to: provide to the UE a first report triggering threshold; receive link performance information with respect to the performance of a user plane between a second network node and the UE; determine, based on the received link performance information, whether the performance of the user plane meets an acceptable performance threshold; and in response to a determination that the performance of the user plane does not meet the acceptable performance threshold, provide to the UE a second report triggering threshold.

Another aspect of the invention provides a computer program product for configuring a dual connectivity user equipment (UE). The computer program product may comprise a non-transitory computer readable medium storing computer readable instructions. The instructions may comprise: instructions for providing to the UE a first report triggering threshold; instructions for receiving link performance information with respect to the performance of a user plane between a second network node and the UE; instructions for determining, based on the received link performance information, whether the performance of the user plane meets an acceptable performance threshold; and instructions for, in response to a determination that the performance of the user plane does not meet the acceptable performance threshold, providing to the UE a second report triggering threshold.

Another aspect of the invention provides a method comprising: a dual connectivity user equipment (UE) receiving a first report triggering threshold from a first network node; the UE determining whether to transmit a first report based on the received first report triggering threshold and a performance of a user plane between a second network node and the UE; based on a determination to transmit the first report, the UE transmitting the first report to the first network node, wherein the first report comprises link performance information relating to the performance of the user plane between the second network node and the UE; the UE receiving a second report triggering threshold; and the UE determining whether to transmit a second report based on the received second report triggering threshold and a performance of the user plane between the second network node and the UE. In some embodiments, the link performance information may comprise one or more of: (i) Reference Signal Received Power (RSRP) information, (ii) Reference Signal Received Quality (RSRQ) information, (iii) channel quality indicator (CQI) information, and (iv) power headroom information.

Another aspect of the invention provides a dual connectivity user equipment (UE) comprising a computer system and a computer readable medium. The computer readable medium may store computer readable instructions executable by said computer system whereby said UE is operative to: receive a first report triggering threshold from a first network node; determine whether to transmit a first report based on the received first report triggering threshold and a performance of a user plane between a second network node and the UE; based on a determination to transmit the first report, transmit the first report to the first network node, wherein the first report comprises link performance information relating to the performance of the user plane between the second network node and the UE; receive a second report triggering threshold; and determine whether to transmit a second report based on the received second report triggering threshold and a performance of the user plane between the second network node and the UE.

In some embodiments, the link performance information may comprise one or more of: (i) Reference Signal Received Power (RSRP) information, (ii) Reference Signal Received Quality (RSRQ) information, (iii) channel quality indicator (CQI) information, and (iv) power headroom information.

Another aspect of the invention provides a computer program product for operating a dual-connectivity user equipment (UE). The computer program product may comprise a non-transitory computer readable medium storing computer readable instructions. The instructions may comprise instructions for transmitting link performance information to a first network node. The link performance information may relate to the performance of a user plane between a second network node and the UE. The instructions may comprise instructions for receiving a message comprising a measurement report triggering parameter based on the transmitted link performance information from the first network node. The instructions may comprise instructions for using the measurement report triggering parameter to determine whether to transmit a report to the first network node.

Another aspect of the invention provides a computer program product for operating a dual-connectivity user equipment (UE). The computer program product may comprise a non-transitory computer readable medium storing computer readable instructions. The instructions may comprise instructions for receiving a first report triggering threshold from a first network node. The instructions may comprise instructions for determining whether to transmit a first report based on the received first report triggering threshold and a performance of a user plane between a second network node and the UE. The instructions may comprise instructions for, based on a determination to transmit the first report, transmitting the first report to the first network node. The first report may comprise link performance information relating to the performance of the user plane between the second network node and the UE. The instructions may comprise instructions for receiving a second report triggering threshold. The instructions may comprise instructions for determining whether to transmit a second report based on the received second report triggering threshold and a performance of the user plane between the second network node and the UE.

Another aspect of this disclosure concerns adaption of report triggering event configurations for one or more User Equipment (UEs) supporting dual connectivity. The adaption of a dual connectivity UE event triggering report may be based on statistical information about the link performance of a low power network node (e.g., a small base station, which may be a Slave eNB (SeNb)). Adapting a report triggering event may include a network node (e.g., a macro eNB, which may function as a Master eNB (MeNB)) gathering statistical information about link performance failures of the low power network node. Adapting a report triggering event may include the network node determining a configuration of a low power network node triggering condition based on the statistical information and/or required or desired low power network node link performance failure statistics. Adapting a report triggering event may include the network node configuring the dual connectivity UE with the new report triggering configuration.

Another aspect of this disclosure provides a method for configuring a dual connectivity user equipment (UE). In some embodiments, the method may comprise: a network node receiving link performance information with respect to a low power network node; the network node determining a measurement report triggering parameter based on the received link performance information; and the network node transmitting to the UE a message comprising the measurement report triggering parameter. The UE may be configured to use the measurement report triggering parameter in determining whether to transmit a report.

In some embodiments, the network node may be an MeNB, and the low power network node may be a SeNB. In some embodiments, the link performance information may comprise one or more of: (i) Reference Signal Received Power (RSRP) information, (ii) Reference Signal Received Quality (RSRQ) information, and (iii) channel quality indicator (CQI) information. In some embodiments, the report trigging parameter may be a threshold value, and the UE may be configured to compare a radio condition (e.g., Reference Signal Received Power (RSRP) or channel quality indicator (CQI)) to the threshold value to determine whether the report should be sent. In some embodiments, the step of determining the report triggering parameter comprises: determining X, where X is the number of connections during a time window, determining Y, where Y is the number of link performance failures that i) corresponds to one or more of an RSRP value, an RSRQ value, and a CQI value and ii) occurred during the time window, determining Y/X, determining that Y/X<t, wherein t is a predetermined threshold, and in response to determining that Y/X is less than t, setting the report triggering parameter equal to the first RSRP value.

Another aspect provides a network node for configuring a dual connectivity user equipment (UE). The network node may comprise a computer system and a computer readable medium. The computer readable medium may store computer readable instructions executable by the computer system. In some embodiments, the network node may be operative to: receive link performance information with respect to a low power network node; determine a measurement report triggering parameter based on the received link performance information; and transmit to the UE a message comprising the measurement report triggering parameter. The UE may be configured to use the measurement report triggering parameter in determining whether to transmit a report.

Another aspect provides a computer program product for configuring a dual-connectivity user equipment (UE). The computer program product may comprise a non-transitory computer readable medium storing computer readable instructions. In some embodiments, the instructions may comprise: instructions for receiving link performance information with respect to a low power network node; instructions for determining a measurement report triggering parameter based on the received link performance information; and instructions for transmitting to the UE a message comprising the measurement report triggering parameter. The UE may be configured to use the measurement report triggering parameter in determining whether to transmit a report.

Another aspect provides a method for configuring a dual connectivity user equipment (UE). In some embodiments, the method may comprise a network node providing to the UE a first report triggering threshold. The UE may be configured to use (a) the first report trigging threshold and (b) a radio condition of a low power network node to determine whether to transmit a report. The method may comprise the network node receiving link performance information with respect to the low power network node; the network node determining, based on the received link performance information, whether the performance of the low power network node meets an acceptable performance threshold; and, in response to a determination that the performance of the low power network node does not meet the acceptable performance threshold, the network node providing to the UE a second report triggering threshold. The UE may be configured such that, after receiving the second report triggering threshold, the UE uses the second report trigging threshold to determine whether to transmit a report.

In some embodiments, the second report triggering threshold may be higher than the first report triggering threshold. In some embodiments, the method may comprise, in response to a determination that the performance of the low power network node meets the acceptable performance threshold, the network node providing to the UE a third report triggering threshold. The UE may be configured such that, after receiving the third report triggering threshold, the UE uses the third report trigging threshold to determine whether to transmit a report. In some embodiments, the third report triggering threshold may be lower than the first report triggering threshold. In other embodiments, the third report triggering threshold may be the same as the first report triggering threshold.

In some embodiments, the network node may be an MeNB, and the low power network node may be a SeNB. In some embodiments, the link performance information comprises one or more of: (i) Reference Signal Received Power (RSRP) information, (ii) Reference Signal Received Quality (RSRQ) information, and (iii) channel quality indicator (CQI) information.

Another aspect provides a network node for configuring a dual connectivity user equipment (UE). The network node may comprise a computer system and a computer readable medium. The computer readable medium may store computer readable instructions executable by the computer system. In some embodiments, the network node may be operative to: provide to the UE a first report triggering threshold; receive link performance information with respect to the low power network node; determine, based on the received link performance information, whether the performance of the low power network node meets an acceptable performance threshold; and, in response to a determination that the performance of the low power network node does not meet the acceptable performance threshold, provide to the UE a second report triggering threshold. In some embodiments, the UE may be configured to use (a) the first report trigging threshold and (b) a radio condition of a low power network node to determine whether to transmit a report. In some embodiments, the UE may be configured such that, after receiving the second report triggering threshold, the UE uses the second report trigging threshold to determine whether to transmit a report

Another aspect provides a computer program product for configuring a dual-connectivity user equipment (UE). The computer program product may comprise a non-transitory computer readable medium storing computer readable instructions. In some embodiments, the instructions may comprise: instructions for providing to the UE a first report triggering threshold; instructions for receiving link performance information with respect to the low power network node; instructions for determining, based on the received link performance information, whether the performance of the low power network node meets an acceptable performance threshold; and instructions for, in response to a determination that the performance of the low power network node does not meet the acceptable performance threshold, providing to the UE a second report triggering threshold. In some embodiments, the UE may be configured to use (a) the first report trigging threshold and (b) a radio condition of a low power network node to determine whether to transmit a report. In some embodiments, the UE may be configured such that, after receiving the second report triggering threshold, the UE uses the second report trigging threshold to determine whether to transmit a report.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments.

FIG. 1 is a dual connectivity network system.

FIGS. 2 and 3 illustrate inter-node radio resource aggregation for dual connectivity architecture scenarios.

FIG. 4 illustrates a handover region where RRC diversity can by applied.

FIG. 5 is a block diagram of an architecture for UL/DL split.

FIG. 6 is a block diagram of user plane architecture bearer split options.

FIGS. 7 and 8 are a block diagrams of user plane architecture alternatives for dual connectivity.

FIG. 9 is a block diagram of Radio Interface C-plane architecture alternatives for dual connectivity.

FIG. 10 is graph illustrating a Radio Link Failure (RLF) detection model.

FIG. 11 illustrates a dual connectivity network system according to some embodiments.

FIG. 12 is a flow chart illustrating a process, according to some embodiments.

FIG. 13 is graph illustrating one example of handover/radio link failure statistics vs. radio condition measurements.

FIG. 14 is a flow chart illustrating a process, according to some embodiments.

FIG. 15 is a message flow diagram according to one scenario.

FIG. 16 is a block diagram of a network node according to some embodiments.

FIG. 17 is another block diagram of a network node according to some embodiments.

FIG. 18 is a block diagram of a UE according to some embodiments.

FIG. 19 is a management system according to some embodiments.

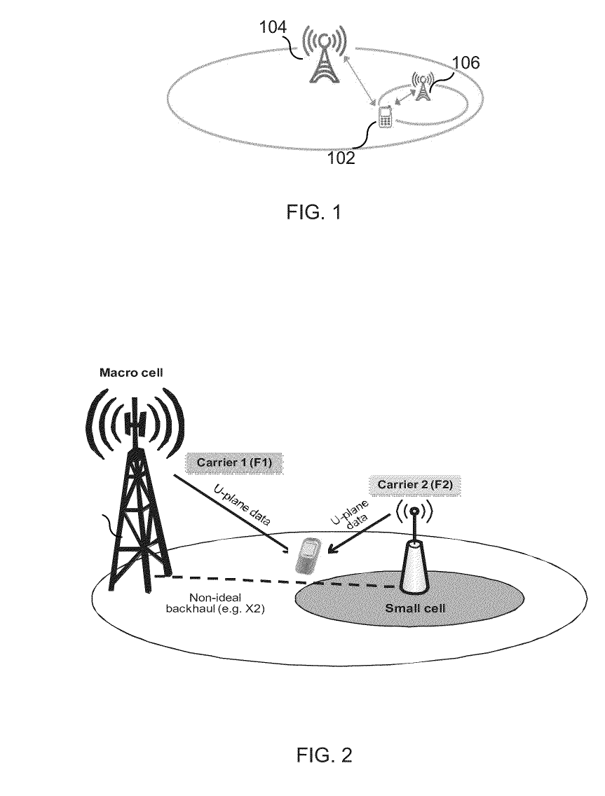

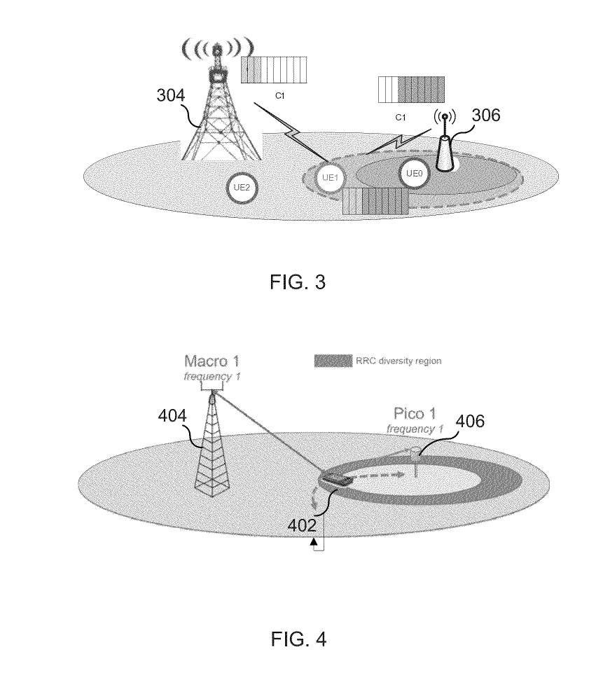

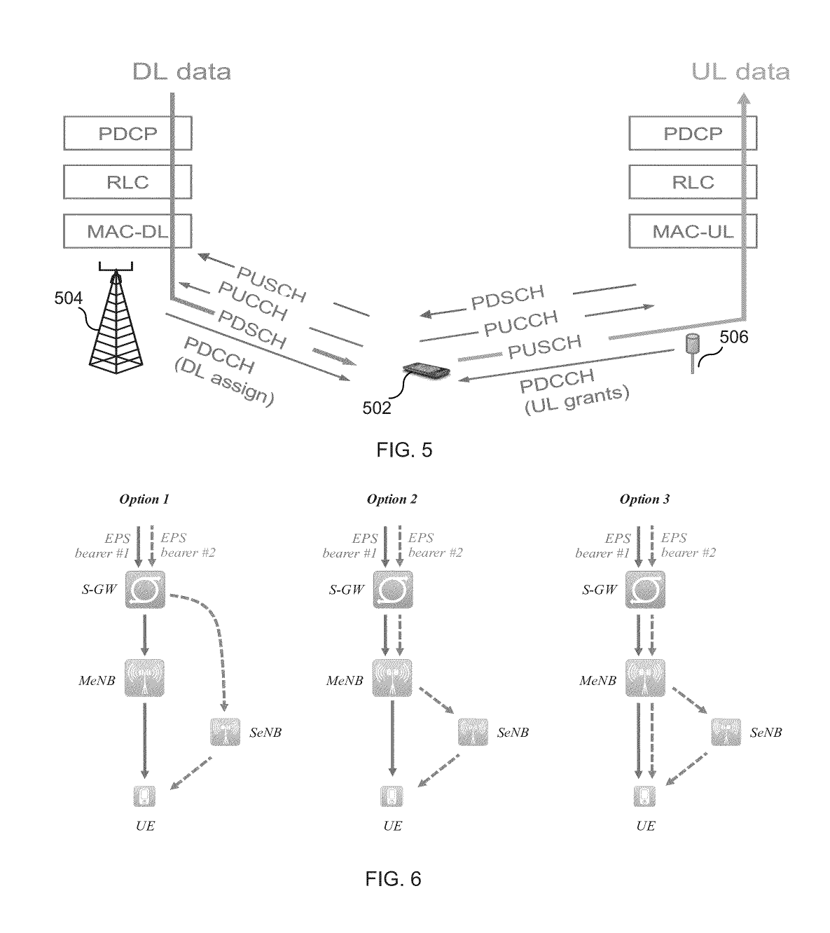

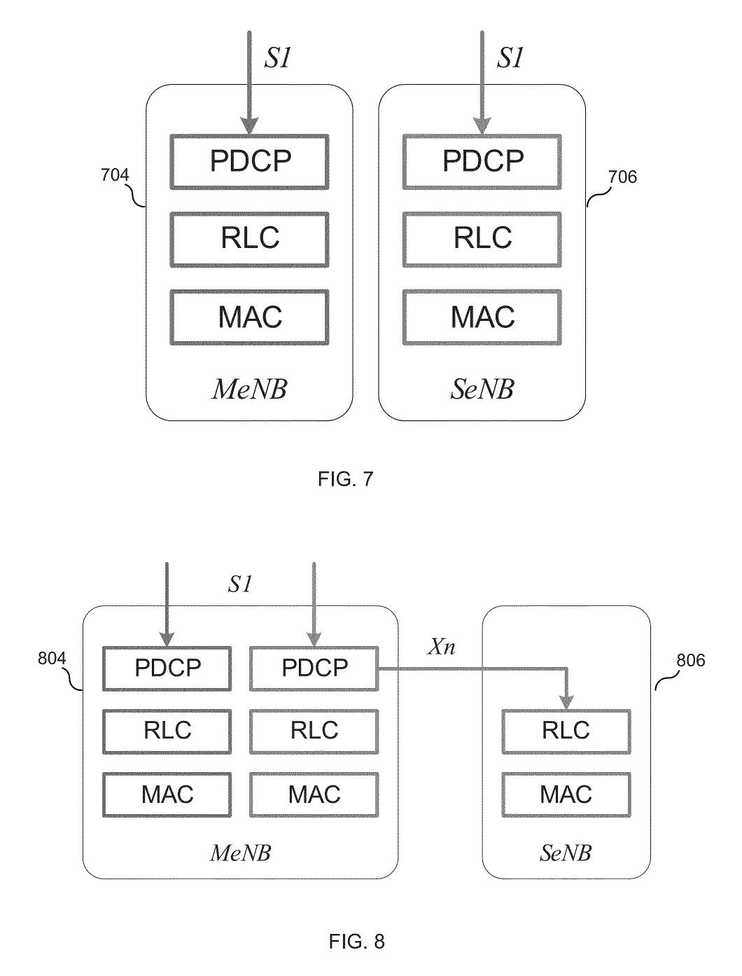

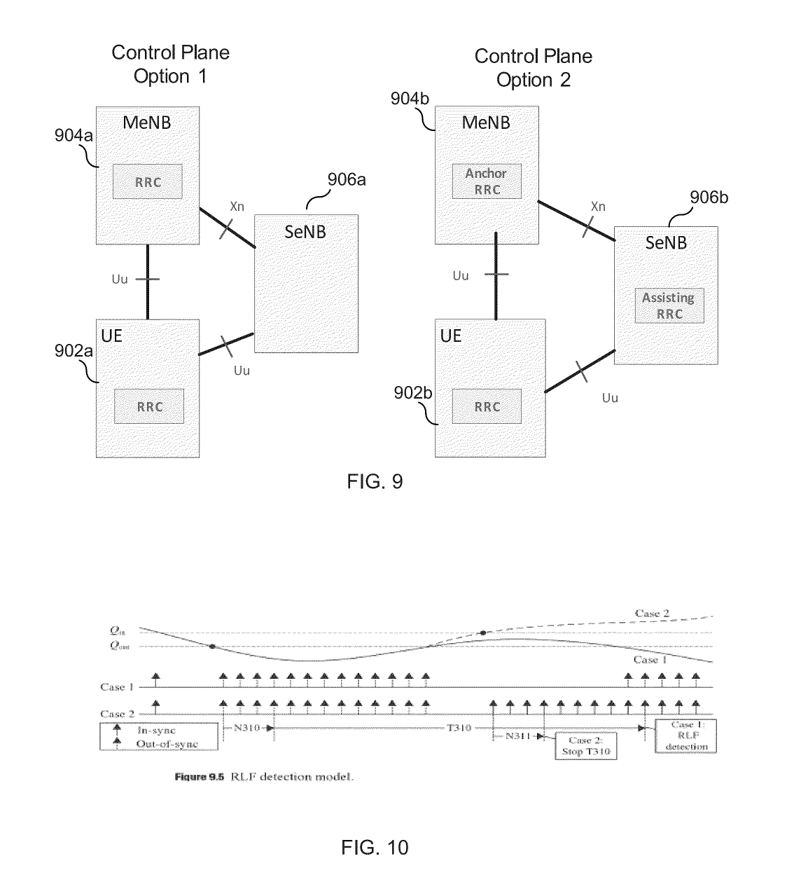

### DETAILED DESCRIPTION

FIG. 11 illustrates a first network node 1104, a second network node 1106 (e.g., a low power network node), and a dual connectivity user equipment (UE) 1102 according to some embodiments. The dual connectivity UE 1102 may consume radio resources provided by at least the first network node 1104 and the second network node 1106. The first network node 1104 and the second network node 1106 may be connected with non-ideal backhaul. In some embodiments, the first network node 1104 may be a macro network node (e.g., a macro base station, such as macro eNBs). In some embodiments, the second network node 1106 may be a pico or femto base station or other small base station, such as a small eNB. In some non-limiting embodiments, dual connectivity may be established using any of the dual connectivity architectures (e.g., UL/DL split architectures, user plane architectures, and/or control plane architectures) described in the background section of this disclosure including, for example, user plane architecture Alternative 1A or 3C and/or control plane Option C1. However, this is not required, and, in alternative embodiments, other architectures for establishing dual connectivity may be used.

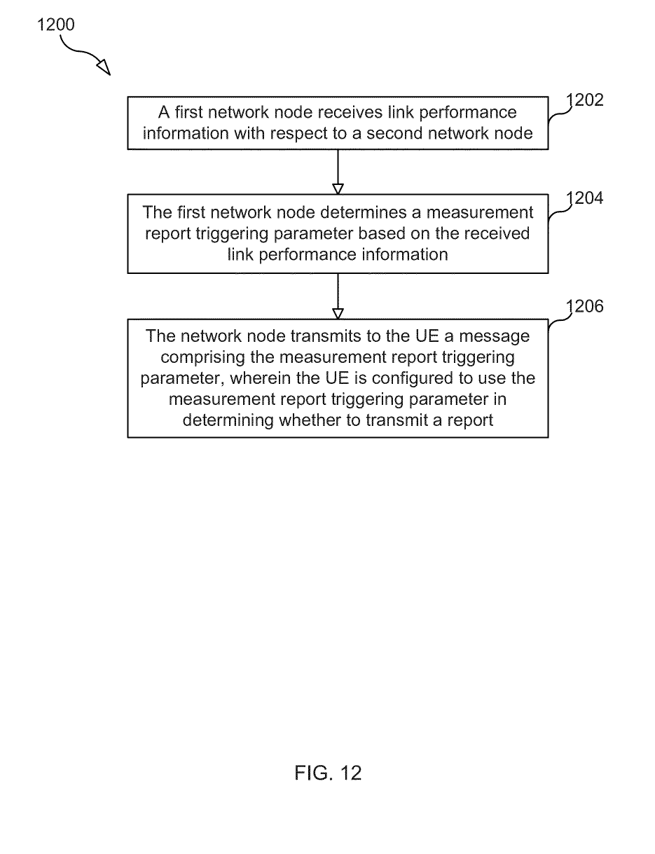

Referring now to FIG. 12, FIG. 12 is a flow chart illustrating a process 1200 for configuring a dual connectivity UE (e.g., UE 1102) according to some embodiments. Process 1200 begins in step 1202, where a network node (e.g., first network node 1104) receives link performance information with respect to the performance of a user plane between a second network node, such as, for example, second network node 1106 (e.g., link performance information with respect to the performance of a user plane between the second network node and the UE). In step 1204, the first network node determines a measurement report triggering parameter based on the received link performance information. In step 1206, the first network node transmits to the UE a message comprising the measurement report triggering parameter.

In some embodiments, the first network node 1104 may be configured to receive link performance information with respect to the second network node 1106 (e.g., in step 1202 of FIG. 12). For example, the link performance information may relate to the performance of a user plane between the second network node 1106 and the UE. In some embodiments, the link performance information may be statistical information regarding the performance of the link provided by the second network node 1106. In some embodiments, the link performance information may be received by the first network node 1104 from one or both of the UE 1102 and second network node 1106. In some embodiments, one or both of the UE 1102 and second network node 1106 monitor the second network node link. The UE 1102 and second network node 1106 may observe potential issues differently.

In some non-limiting embodiments, the UE 1102 may monitor and report the second network node link channel state information to the second network node 1106. The link channel state information may be essentially the same (except when the UE feedback gets corrupted), and either (or both) of the UE 1102 and the second network node 1106 can aggregate data and signal it to the first network node 1104. In some non-limiting embodiments, only the second network node 1106 conveys the link performance information to the first network node 1104 because, in contrast to the first network node 1104-second network node 1106 connection capacity (e.g., the MeNB-SeNB connection capacity), the connection capacity of the first network node 1104 with the UE 1102 may be limiting.

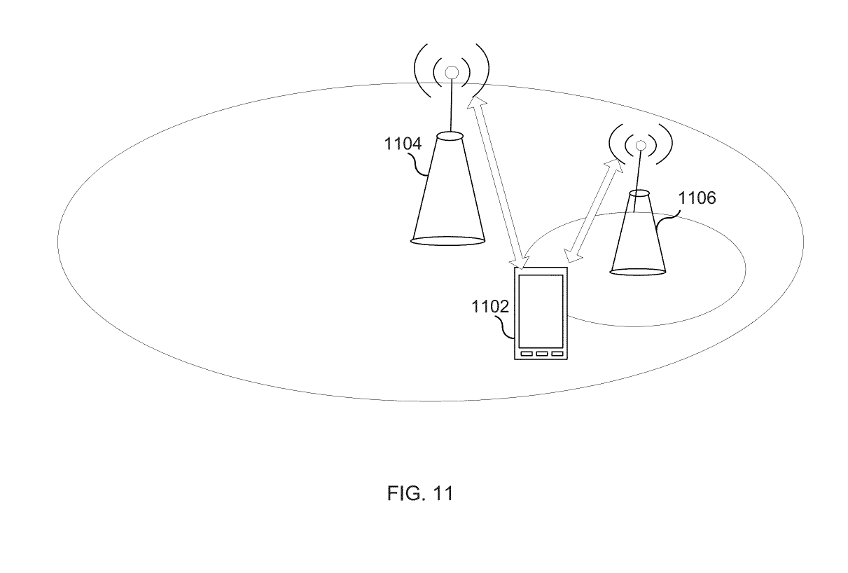

In some embodiments, the link performance information may additionally or alternatively be based on an indication that the link performance of the second network node 1106 is considered inadequate. In some non-limiting embodiments, the link performance of the second network node 1106 may be considered inadequate if a filtered radio condition measurements value is below a threshold (e.g., over a time window). In some alternative embodiments, the link performance of the second network node 1106 may be considered inadequate in a manner similar to the physical layer radio link failure (RLF) declaration (see FIG. 10). For instance, the UE 1102 may monitor Qout (or similar threshold) with a time window and may monitor Qin (or similar threshold) with another time window. If the UE 1102 detects that its average wideband radio condition value (e.g., CQI, RSRP, power headroom (difference between the power level the UE desires to use and the max UE power), etc) is lower than Qout, the UE 1102 may report an out-of-sync event. Thereafter, if the UE 1102 detects that its average wideband radio condition value (e.g., CQI, RSRP, power headroom, etc) is higher than Qin, it will report an in-sync event. When the out-of-sync event has been reported N310_1 times, the eNB will start T310_1 timer, which is the time limit to decide whether an inadequate SeNB link performance occurs. If the in-sync event is detected less than N311_1 times when the T310_1 timer expires, an inadequate SeNB link performance occurs. Otherwise, the T310_1 timer is aborted.

In some alternative embodiments, the UE 1102 may consider the link performance of the second network node 1106 inadequate if the UE 1102 observes random access procedure problems with respect to the second network node 1106 (e.g., the random access procedure has not succeeded after a configurable or pre-configured number of attempts, after a configurable or pre-configured time, etc.). In some alternative embodiments, the UE 1102 may consider the link performance of the second network node 1106 inadequate if the UE 1102 observes radio link control problems with respect to the SeNB (e.g., reaching a max number of RLC retransmissions).

In some embodiments, the link performance information may be based on a failure of the second network node link (e.g., a failure triggered by a link performance evaluation as indicated above), and the UE 1102 may store information about the failure. In some embodiments, the UE 1102 may store information about the failure in a second network node connection failure indication report. The failure report may comprise radio condition measurements for the time of failure, the time of failure itself, position information with respect to the time of failure, whether the failure concerns all bearers at the second network node 1106, and/or a subset of the bearers, etc. These bearers may be grouped, for example, in logical channel groups. In general, the UE 1102 may store any measurement and/or conditions and/or context related to the user plane or control plane of the second network node 1106 and include the stored information in the report to the first network node 1104.

In some alternative embodiments, the UE 1102 may store one or more measurements collected before the bearer drop (e.g., both user plane measurements such as, for example, CQI and UL Power Headroom and control channel measurements such as, for example, RSRP/RSRQ. In some non-limiting embodiments, the UE 1102 may store the collected measurements in an enhanced version of the VarRLFReport under a new container IE collecting information about failure events of the second network node 1106.

In some alternative embodiments, the UE 1102 may send only a failure indication to the first network node 1104 about a link performance failure of the second network node 1106. In some non-limiting embodiments, the failure indication may include an indication about the availability of a failure report, or the transmission of the failure indication message itself may imply that a report including collected measurements is available. The implied or explicit availability indication may inform the first network node 1104 about the report availability, the first network node 1104 may request the report, and the UE 1102 may respond with the report after receiving the request from the first network node 1104. In some non-limiting embodiments, the first network node 1104 may use a RRC UE Information Request, and the UE may use an RRC UE Information Response in this exchange of information and report.

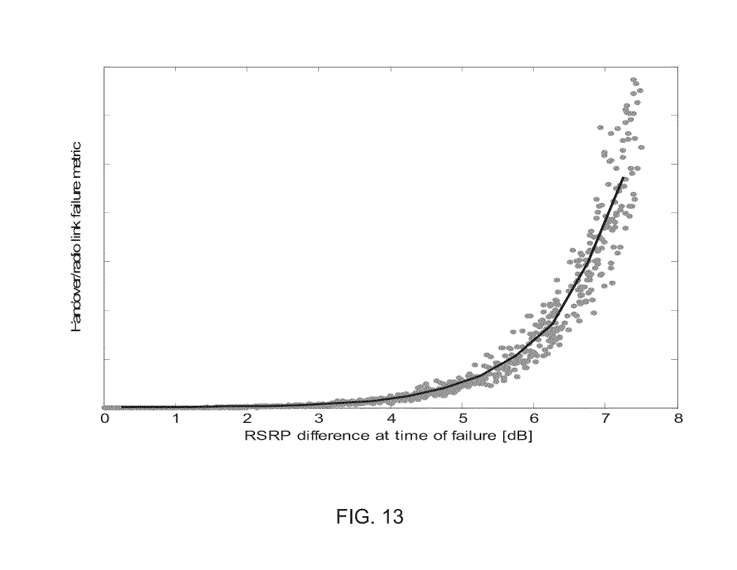

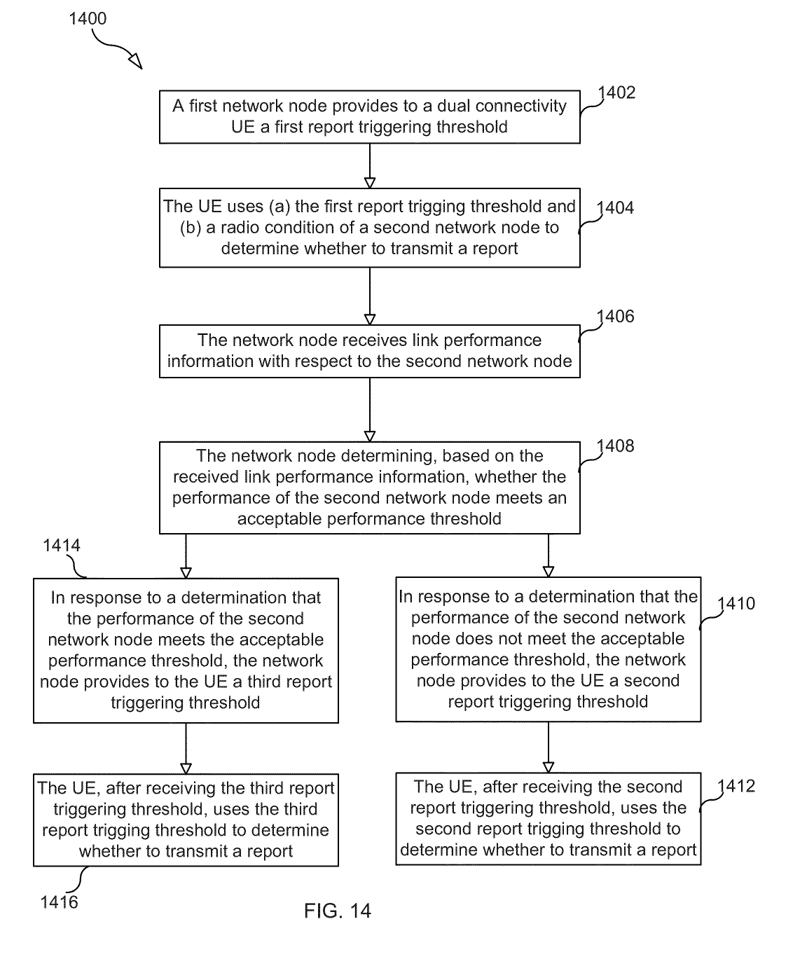

FIG. 13 illustrates a non-limiting example of handover and/or radio link failure statistics versus the Reference Signal Received Power (RSRP) difference between a non-serving cell (typically the best) and serving cell. In some embodiments, the failure statistics may be one or more of: (i) a number of link performance failure events, (ii) a number of link performance failure events per number of users (e.g., in the considered set of UEs); and (iii) a number of failure events in comparison to the number of UEs served by the second network node. For another example, similar results are obtained for handover and/or radio link failure statistics versus asolute SeNB RSRP values.

In some embodiments, the first network node 1104 may be configured to determine a measurement report triggering parameter based on the received link performance information (e.g., in step 1204 of FIG. 12) and to reconfigure the UE 1102 (e.g., by transmitting to the UE 1102 a message comprising the measurement report triggering parameter such as, for example, in step 1206 of FIG. 12). In some non-limiting embodiments, the first network node 1104 may use the received link performance information (e.g., the link performance information signaled by the UE 1102) to prevent or reduce future unexpected user plane drops. For instance, in an embodiment in which the first network node 1104 is a control plane (CP) anchor point eNB, the first network node 1104 may use the received link performance information to prevent or reduce future unexpected user plane drops. For example, provided that the CP anchor eNB is aware of user plane data channel measurements collected and reported by the UE, the CP anchor eNB may use measurements signaled by the UE and collected just before the user plane (UP) bearer failure to anticipate (or in general adjust) the triggering conditions for removal or transfer of the bearer at the node serving it or transfer of the same UP bearer to a neighboring cell.

In some alternative embodiments where the first network node 1104 is a CP anchor point eNB, the CP anchor point eNB may pass the link performance information signalled by the UE 1102 (and relative to the user plane bearer drop) to the node that was serving the bearer before the unexpected failure occurred. If such node is aware of served UP bearer measurements, it may use the measurements signalled by the UE 1102 and received from the CP anchor point eNB to anticipate removal or transfer of the bearer at the node serving it or transfer of the same UP bearer to a neighbouring cell.

In some embodiments where the first network node 1104 is a CP anchor point eNB, the CP anchor eNB may also use control channel measurements collected by the UE 1102 on reference signals of the cell where the user plane bearer was dropped in order to deduce more information about optimal bearer release/transfer points. In fact, in the example of dual connectivity, the CP anchor point or MeNB may be aware of the RSRP/RSRQ collected on the reference signals of the SeNB cell.

In some embodiments, the first network node 1104 may keep a buffer of previous RSRP/RSRQ values for the low power network node 1106 cell or monitor and/or store such measurements upon decreases of CQI and UL Power Headroom below pre-fix thresholds, and the first network node 1104 may correlate user plane measurements reported by the UE 1102 before failure to the second network node 1106 with the RSRP and/or RSRQ of the second network node 1106 cell before the failure.

By organizing the received link performance information (e.g., statistical information) based on radio conditions, the first network node 1104 may relate failure probability to the radio condition (either relative to the first network node 1104 radio condition or in absolute terms). For example, based on the statistical data and a requirement on failure rate or probability, it is possible to determine a radio condition threshold below which the failure rate is worse than the requirements. The first network node 1104 may use this threshold as part of a measurement report triggering parameter that makes the UE 1102 report to the first network node 1104 that the observed low power network node 1106 radio conditions are below the configured threshold. In other words, the first network node 1104 may gather historical information regarding link failures and the radio conditions that existed at the time of the link failures. The first network node may then perform an analysis to correlate the link failures with the radio conditions and determine a probability of link failure given certain radio conditions. The analysis may be a regression analysis such as, for example, linear regression. However, this is not required, and, in some alternatives, the analysis may be to bin the failures by what radio conditions they experience and the reason for the experience. If, for example, there are X connections during a time window T, and Y(RSRP) failures during the same time window, where Y(RSRP) is the no of failures with radio conditions equal to RSRP. Then, in some non-limiting embodiments, the first network node 1104 may determine the triggering threshold RSRPthres as the one that gives Y(RSRPthres)/X<threshold.

Referring now to FIG. 14, FIG. 14 is a flow chart illustrating a process 1400 for configuring a dual connectivity UE (e.g., UE 1102) according to some embodiments. Process 1400 begins in step 1402, where a first network node (e.g., first network node 1104) provides to a dual connectivity UE (e.g., UE 1102) a first report triggering threshold. In step 1404, the UE, which may be configured to use (a) the first report trigging threshold and (b) a radio condition of a second network node to determine whether to transmit a report, uses the (a) the first report trigging threshold and (b) the radio condition of a second network node (e.g., second network node 1106) to determine whether to transmit the report. In step 1406, the first network node receives link performance information with respect to the second network node (e.g., link performance information with respect to the performance of the user plane between the second network node and the UE). In step 1408, the first network node determines, based on the received link performance information, whether the performance of the user plane meets an acceptable performance threshold. In step 1410, in response to a determination that the performance of the user plane does not meet the acceptable performance threshold, the first network node provides to the UE a second report triggering threshold. In some embodiments, the second report triggering threshold may be higher than the first report triggering threshold. In step 1412, the UE, after receiving the second report triggering threshold, uses the second report trigging threshold (e.g., instead of the first report triggering threshold) to determine whether to transmit a report. In step 1414, in response to a determination that the performance of the second network node meets the acceptable performance threshold, the first network node may provide to the UE a third report triggering threshold. In some embodiments, the third report triggering threshold may be lower than or the same as the first report triggering threshold. In step, 1416, the UE, after receiving the third report triggering threshold, uses the third report trigging threshold (e.g., instead of the first report triggering threshold) to determine whether to transmit a report.

In some embodiments, the first network node may be configured to configure a report triggering threshold in one or more UEs that are configured with dual connectivity (e.g., by transmitting to UE 1102 a message comprising the report triggering threshold such as, for example, in step 1402 of FIG. 14). The first network node 1104 may be configured to gather link performance information (e.g., statistical information) in a time period (e.g., by receiving link performance information in step 1406 of FIG. 14). In some embodiments, the report triggering threshold is a threshold, and the UE 1102 triggers a report when the observed second network node 1106 radio condition is below the threshold (e.g., over a time window). In some non-limiting embodiments, the radio condition may be a filtered radio condition, but this is not required. In some non-limiting embodiments, the first network node 1104 may interpret the reception of the link performance information (e.g., the report) as an indication that the second network node 1106 link performance is inadequate, and, in some embodiments, the first network node 1104 may release the second network node 1106 link in response to receiving the link performance information.

In some embodiments, the first network node 1104 may gather link performance information (e.g., statistical information) within a time window or until a certain number of measurements have been received (e.g., in step 1406 of FIG. 14). If the first network node 1104 determines (e.g., in step 1408 of FIG. 14) that the link performance information indicates that the performance of the second network node 1106 is unacceptable (e.g., by evaluating a second network node 1106 failure ratio), then the first network node 1104 may configure current and/or future UEs with a new (e.g., increased) report triggering threshold (e.g., by providing an increased report triggering threshold to the UE 1102). If the first network node 1104 determines (e.g., in step 1408 of FIG. 14) that the link performance information indicates that the performance of the low power network node 1106 is acceptable (e.g., by evaluating a second network node 1106 failure ratio), then the first network node 1104 may configure current and/or future UEs with a new (e.g., fixed or reduced) report triggering threshold (e.g., by providing a reduced report triggering threshold to the UE 1102).

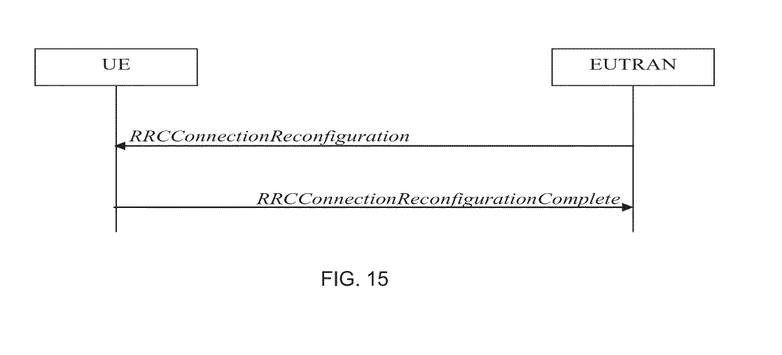

In some non-limiting E-UTRAN embodiments, as illustrated in FIG. 15, the first network node 1104 may use RRC Connection Reconfiguration (3GPP 36.331, section 5) as the message/information element is used to transmit to the UE (e.g., to transmit a report triggering parameter in step 1206 of FIG. 12 and/or to transmit a report triggering threshold in steps 1402, 1412, and/or 1416 of FIG. 14). However, this is not requirement, and, in alternative embodiments, the first network node 1104 a different message/information element.

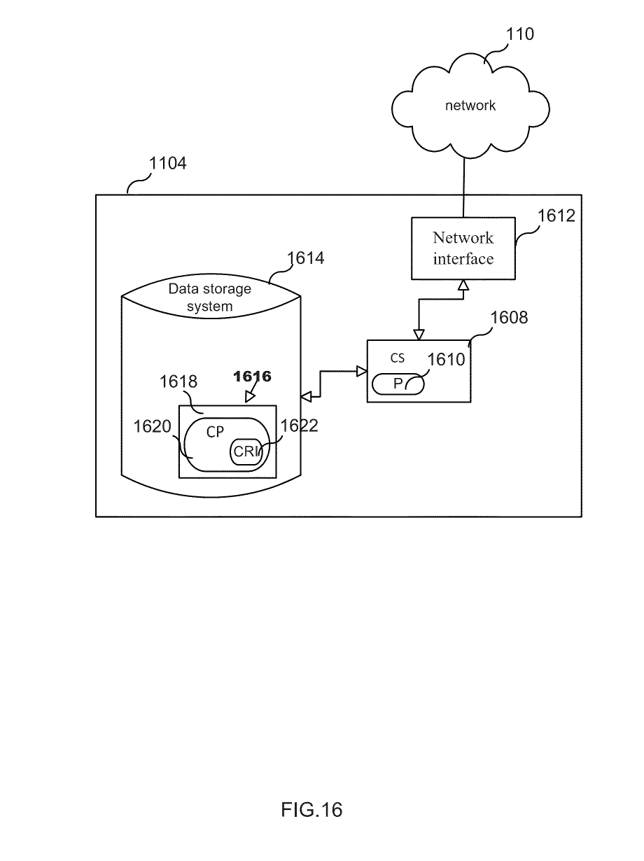

FIG. 16 is a block diagram of an embodiment of first network node 1104. As shown in FIG. 16, first network node 1104 may include or consist of: a computer system (CS) 1608, which may include one or more processors 1610 (e.g., a general purpose microprocessor) and/or one or more circuits, such as an application specific integrated circuit (ASIC), field-programmable gate arrays (FPGAs), a logic circuit, and the like; a network interface 1612 for use in connecting network node 1104 to a network; and a data storage system 1614, which may include one or more non-volatile storage devices and/or one or more volatile storage devices (e.g., random access memory (RAM)). In embodiments where first network node 1104 includes a processor 1610, a computer program product (CPP) 1616 may be provided. CPP 1616 includes or is a computer readable medium (CRM) 1618 storing a computer program 1620 comprising computer readable instructions (CRI) 1622. CRM 1618 is a non-transitory computer readable medium, such as, but not limited, to magnetic media (e.g., a hard disk), optical media (e.g., a DVD), solid state devices (e.g., random access memory (RAM), flash memory), and the like. In some embodiments, the CRI 1622 of computer program 1620 is configured such that when executed by computer system 1608, the CRI causes the first network node 1104 to perform steps described above (e.g., steps described above with reference to the flow charts shown in the drawings). In other embodiments, first network node 1104 may be configured to perform steps described herein without the need for a computer program. That is, for example, computer system 1608 may consist merely of one or more ASICs. Hence, the features of the embodiments described herein may be implemented in hardware and/or software.

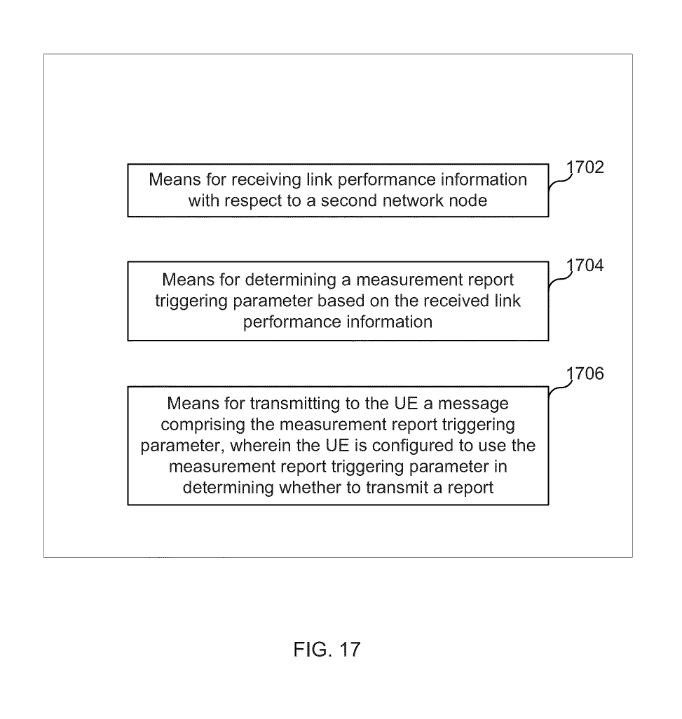

FIG. 17 is a functional block diagram of node 1104, according to some embodiments. As shown in FIG. 17, node 1104 may include: means (1702) for receiving link performance information with respect to a second network node, such as, for example second network node 1106 (e.g., link performance information with respect to the performance of a user plane between the second network node and the UE); means (1704) for determining a measurement report triggering parameter based on the received link performance information; and means (1706) for transmitting to the UE a message comprising the measurement report triggering parameter.

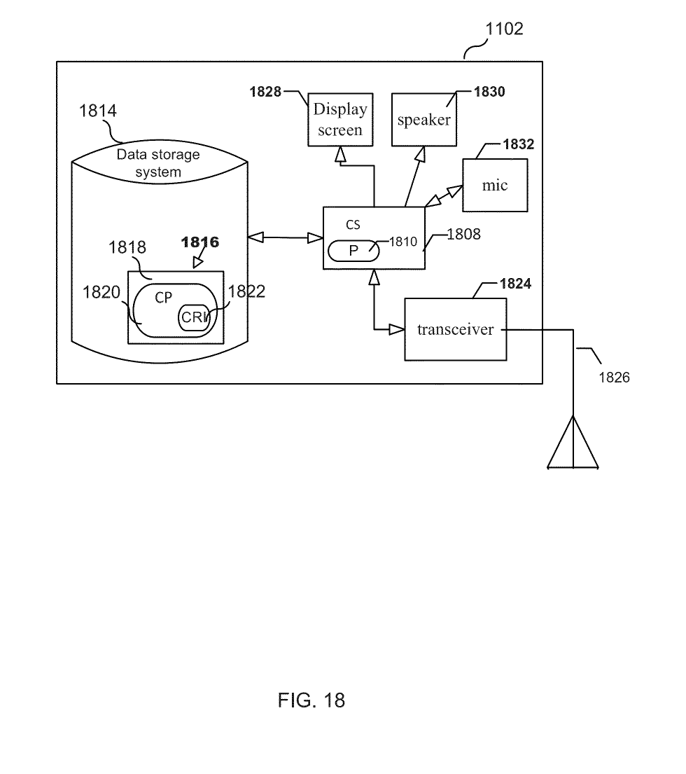

FIG. 18 is a block diagram of a dual connectivity UE 1102 according to some embodiments. As shown in FIG. 18, UE 1102 may include or consist of: a computer system (CS) 1808, which may include one or more processors 1810 (e.g., a general purpose microprocessor) and/or one or more circuits, such as an application specific integrated circuit (ASIC), field-programmable gate arrays (FPGAs), a logic circuit, and the like; a transceiver 1824, coupled to an antenna 1826 for transmitting and receiving data wireless; and a data storage system 1814, which may include one or more non-volatile storage devices and/or one or more volatile storage devices (e.g., random access memory (RAM)). In embodiments where UE 1102 includes a processor 1810, a computer program product (CPP) 1816 may be provided. CPP 1816 includes or is a computer readable medium (CRM) 1818 storing a computer program 1820 comprising computer readable instructions (CRI) 1822. CRM 1822 is a non-transitory computer readable medium, such as, but not limited, to magnetic media (e.g., a hard disk), optical media (e.g., a DVD), solid state devices (e.g., random access memory (RAM), flash memory), and the like. In some embodiments, the CRI 1822 of computer program 1820 is configured such that when executed by computer system 1808, the CRI causes the UE 1102 to perform steps described above (e.g., steps described above with reference to the flow charts shown in the drawings). In other embodiments, UE 1102 may be configured to perform steps described herein without the need for a computer program. That is, for example, computer system 1808 may consist merely of one or more ASICs. Hence, the features of the embodiments described herein may be implemented in hardware and/or software. As shown in FIG. 18, UE 1102 may include: a display screen 1828, a speaker 1830, and a microphone (“mic”) 1832, all of which are coupled to CS 1808.

In some embodiments, the dual connectivity UE 1102 may monitor and report on events relative to a bearer served by second network node 1106 different from the first network node 1104 (e.g., a user plane anchor point network node for a UE). In some embodiments, statistics associated to this bearer together with statistics relative to measurements on reference signals of the cell serving the bearer are monitored. In some embodiments, the first network node 1104 may deduce when a bearer is released due to a bearer drop. In some embodiments, in case of unexpected bearer drop, the first network node 1104 may receive from UE 1102 reports with relevant statistics concerning the failure, and the first network node 1104 may use the statistics to take preventive actions to avoid such failures in the future.

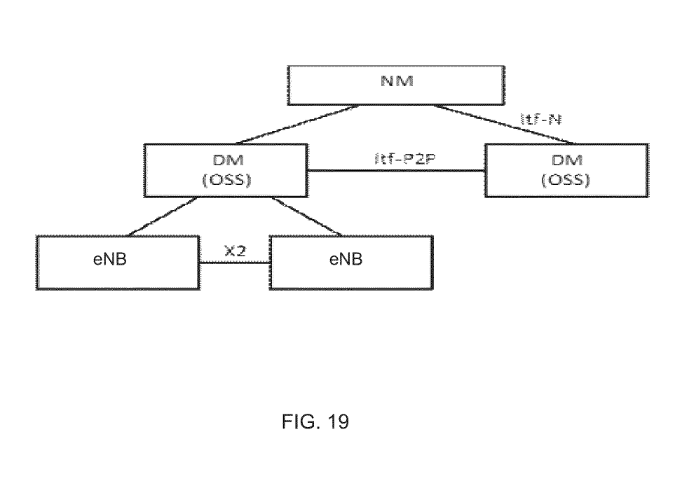

The management system assumed in this disclosure is shown in FIG. 19. The eNBs, are managed by a domain manager (DM) network node, also referred to as the operation and support system (OSS). A DM network node may further be managed by a network manager (NM) network node. Two eNBs are interfaced by the X2 interface, whereas the interface between two DM network nodes is referred to as the Itf-P2P interface. The management system may configure the eNBs, as well as receive observations associated to features in the eNBs. For example, DM observes and configures eNBs, while NM observes and configures DM, as well as NE via DM.

In one embodiment, an eNB (e.g., a MeNB) forwards the statistical information to a network node in the management system (e.g., a DM network node), either regularly, on demand, or when a certain condition is met (for example the number of SeNB connection or failures have exceeded a configurable threshold). In another embodiment, the MeNB is configured with the thresholds and parameters that controls the mechanisms that are used by the MeNB to adjust the event triggering condition.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

What is claimed is:

1. A method for configuring a dual connectivity user equipment (UE), the method comprising:
a first network node receiving link performance information with respect to the performance of a user plane between a second network node and the UE;
the first network node determining a measurement report triggering parameter based on the received link performance information; and
the first network node transmitting to the UE a message comprising the measurement report triggering parameter.

2. The method of claim 1, wherein the link performance information comprises one or more of: (i) Reference Signal Received Power (RSRP) information, (ii) Reference Signal Received Quality (RSRQ) information, (iii) channel quality indicator (CQI) information, and (iv) power headroom information.

3. The method of claim 2, wherein the link performance information comprises one or more of the CQI information and the power headroom information.

4. The method of claim 2, wherein the link performance information comprises (a) one or more of the RSRP information and RSRQ information and (b) one or more of the CQI information and the power headroom information.

5. The method of claim 2, wherein the first network node uses the link performance information to decide whether to perform bearer release/transfer.

6. The method of claim 1, wherein the first network node is a macro node, and the second network node is a low power network node.

7. The method of claim 1, wherein the step of determining the report triggering parameter comprises calculating a rate of failure with respect to connection attempts.

8. The method of claim 7, wherein calculating the rate of failure with respect to connection attempts comprises:
determining X, where X is the number of connections during a time window,
determining Y, where Y is the number of link performance failures that i) corresponds to one or more of an RSRP value, an RSRQ value, a CQI value, and a power headroom value and ii) occurred during the time window,
determining Y/X,
determining whether Y/X<t, wherein t is a predetermined threshold, and
in response to determining that Y/X is less than t, setting the report triggering parameter equal to the one or more of the RSRP value, the RSRQ value, the CQI value, and the power headroom value.

9. A network node for configuring a dual connectivity user equipment (UE), the network node comprising a computer system and a computer readable medium, said computer readable medium storing computer readable instructions executable by said computer system whereby said network node is operative to:
receive link performance information with respect to the performance of a user plane between a second network node and the UE;
determine a measurement report triggering parameter based on the received link performance information; and
transmit to the UE a message comprising the measurement report triggering parameter.

10. A computer program product for configuring a dual-connectivity user equipment (UE), the computer program product comprising a non-transitory computer readable medium storing computer readable instructions, the instructions comprising:
instructions for receiving link performance information with respect to the performance of a user plane between a second network node and the UE;
instructions for determining a measurement report triggering parameter based on the received link performance information; and
instructions for transmitting to the UE a message comprising the measurement report triggering parameter.

11. A method comprising:
a dual connectivity user equipment (UE) transmitting link performance information to a first network node, wherein the link performance information relates to the performance of a user plane between a second network node and the UE;
the UE receiving a message comprising a measurement report triggering parameter based on the transmitted link performance information from the first network node; and
the UE using the measurement report triggering parameter to determine whether to transmit a report to the first network node.

12. The method of claim 11, wherein the link performance information comprises one or more of: (i) Reference Signal Received Power (RSRP) information, (ii) Reference Signal Received Quality (RSRQ) information, (iii) channel quality indicator (CQI) information, and (iv) power headroom information.

13. The method of claim 11, wherein the report trigging parameter is a threshold value, and using the measurement report triggering parameter to determine whether to transmit the report to the first network node comprises the UE comparing a radio condition to the threshold value to determine whether the report should be sent to the first network node.

14. The method of claim 13, wherein the radio condition is Reference Signal Received Power (RSRP), Reference Signal Received Quality (RSRQ), or channel quality indicator (CQI).

15. A dual connectivity user equipment (UE) comprising a computer system and a computer readable medium, said computer readable medium storing computer readable instructions executable by said computer system whereby said UE is operative to:
transmit link performance information to a first network node, wherein the link performance information relates to the performance of a user plane between a second network node and the UE;
receive a message comprising a measurement report triggering parameter based on the transmitted link performance information from the first network node; and
use the measurement report triggering parameter to determine whether to transmit a report to the first network node.

16. The UE of claim 15, wherein the link performance information comprises one or more of: (i) Reference Signal Received Power (RSRP) information, (ii) Reference Signal Received Quality (RSRQ) information, (iii) channel quality indicator (CQI) information, and (iv) power headroom information.

17. The UE of claim 15, wherein the report trigging parameter is a threshold value, and using the measurement report triggering parameter to determine whether to transmit the report to the first network node comprises comparing a radio condition to the threshold value to determine whether the report should be sent to the first network node.

18. A method for configuring a dual connectivity user equipment (UE), the method comprising:
a first network node providing to the UE a first report triggering threshold;
the first network node receiving link performance information with respect to the performance of a user plane between a second network node and the UE;
the first network node determining, based on the received link performance information, whether the performance of the user plane meets an acceptable performance threshold; and
in response to a determination that the performance of the user plane does not meet the acceptable performance threshold, the first network node providing to the UE a second report triggering threshold.

19. The method of claim 18, wherein the second report triggering threshold is higher than the first report triggering threshold.

20. The method of claim 18, further comprising, in response to a determination that the performance of the user plane meets the acceptable performance threshold, the first network node providing to the UE a third report triggering threshold.

21. The method of claim 20, wherein the third report triggering threshold is lower than the first report triggering threshold.

22. The method of claim 20, wherein the third report triggering threshold is the same as the first report triggering threshold.

23. The method of claim 18, wherein the link performance information comprises one or more of: (i) Reference Signal Received Power (RSRP) information, (ii) Reference Signal Received Quality (RSRQ) information, (iii) channel quality indicator (CQI) information, and (iv) power headroom information.

24. The method of claim 23, wherein the link performance information comprises one or more of the CQI information and the power headroom information.

25. The method of claim 23, wherein the link performance information comprises (a) one or more of the RSRP information and RSRQ information and (b) one or more of the CQI information and the power headroom information.

26. The method of claim 23, wherein the first network node uses the link performance information to decide whether to perform bearer release/transfer.

27. The method of claims 18, wherein the first network node is a macro node, and the second network node is a low power network node.

28. A network node for configuring a dual connectivity user equipment (UE), the network node comprising a computer system and a computer readable medium, said computer readable medium storing computer readable instructions executable by said computer system whereby said network node is operative to:
provide to the UE a first report triggering threshold;
receive link performance information with respect to the performance of a user plane between a second network node and the UE;
determine, based on the received link performance information, whether the performance of the user plane meets an acceptable performance threshold; and
in response to a determination that the performance of the user plane does not meet the acceptable performance threshold, provide to the UE a second report triggering threshold.

29. A computer program product for configuring a dual connectivity user equipment (UE), the computer program product comprising a non-transitory computer readable medium storing computer readable instructions, the instructions comprising:
instructions for providing to the UE a first report triggering threshold;
instructions for receiving link performance information with respect to the performance of a user plane between a second network node and the UE;
instructions for determining, based on the received link performance information, whether the performance of the user plane meets an acceptable performance threshold; and
instructions for, in response to a determination that the performance of the user plane does not meet the acceptable performance threshold, providing to the UE a second report triggering threshold.

30. A method comprising:
a dual connectivity user equipment (UE) receiving a first report triggering threshold from a first network node;
the UE determining whether to transmit a first report based on the received first report triggering threshold and a performance of a user plane between a second network node and the UE;
based on a determination to transmit the first report, the UE transmitting the first report to the first network node, wherein the first report comprises link performance information relating to the performance of the user plane between the second network node and the UE;
the UE receiving a second report triggering threshold; and
the UE determining whether to transmit a second report based on the received second report triggering threshold and a performance of the user plane between the second network node and the UE.

31. The method of claim 30, wherein the link performance information comprises one or more of: (i) Reference Signal Received Power (RSRP) information, (ii) Reference Signal Received Quality (RSRQ) information, (iii) channel quality indicator (CQI) information, and (iv) power headroom information.

32. A dual connectivity user equipment (UE) comprising a computer system and a computer readable medium, said computer readable medium storing computer readable instructions executable by said computer system whereby said UE is operative to:
receive a first report triggering threshold from a first network node;
determine whether to transmit a first report based on the received first report triggering threshold and a performance of a user plane between a second network node and the UE;
based on a determination to transmit the first report, transmit the first report to the first network node, wherein the first report comprises link performance information relating to the performance of the user plane between the second network node and the UE;
receive a second report triggering threshold; and
determine whether to transmit a second report based on the received second report triggering threshold and a performance of the user plane between the second network node and the UE.

33. The UE of claim 32, wherein the link performance information comprises one or more of: (i) Reference Signal Received Power (RSRP) information, (ii) Reference Signal Received Quality (RSRQ) information, (iii) channel quality indicator (CQI) information, and (iv) power headroom information.

34. A computer program product for operating a dual-connectivity user equipment (UE), the computer program product comprising a non-transitory computer readable medium storing computer readable instructions, the instructions comprising:
instructions for transmitting link performance information to a first network node, wherein the link performance information relates to the performance of a user plane between a second network node and the UE;
instructions for receiving a message comprising a measurement report triggering parameter based on the transmitted link performance information from the first network node; and
instructions for using the measurement report triggering parameter to determine whether to transmit a report to the first network node.

35. A computer program product for operating a dual-connectivity user equipment (UE), the computer program product comprising a non-transitory computer readable medium storing computer readable instructions, the instructions comprising:
instructions for receiving a first report triggering threshold from a first network node;
instructions for determining whether to transmit a first report based on the received first report triggering threshold and a performance of a user plane between a second network node and the UE;
instructions for, based on a determination to transmit the first report, transmitting the first report to the first network node, wherein the first report comprises link performance information relating to the performance of the user plane between the second network node and the UE;
instructions for receiving a second report triggering threshold; and
instructions for determining whether to transmit a second report based on the received second report triggering threshold and a performance of the user plane between the second network node and the UE.
